(19) United States
(12) Patent Application Publication
(10) Pub. No.: US 2006/0177295 A1
(43) Pub. Date: Aug. 10, 2006

(54) Buckling arm robot

(76) Inventors: Hansrued Frueh, Aadorf (CH); Thomas Bretscher, Winterthur (CH); Christian Gfeller, Zurich (CH)

Correspondence Address: BUCHANAN INGERSOLL PC;(INCLUDING BURNS, DOANE, SWECKER & MATHIS), POST OFFICE BOX 1404, ALEXANDRIA, VA, 22313-1404, US

(21) Appl. No.: 10/475,325

(22) PCT Filed: Apr. 19, 2002
(86) PCT No.: PCT/CH02/00216

§ 371 Date: Feb. 27, 2004

(30) Foreign Application Priority Data
Apr. 22, 2001 (CH) 731/01

(51) Int. Cl. B66C 23/00

(52) U.S. Cl. 414/695.8

(57) ABSTRACT

The invention relates to a buckling arm robot comprising a base element (1), at least two articulation blocks (5, 11), at least three support tubes (9, 16, 16′), a working element (30), mechanical and electric drive elements, power supply elements (28) and external computer performance elements (32). The power electronics are completely integrated into the buckling arm robot. In order to control the position, a micro-computer is allocated to each motor-gearing unit in close proximity to the latter. Said arrangement provides an internal computer performance, which is locally distributed among the mechanical drive elements and the working element (30), thus forming a local intelligence. An external interface (26) provides access to the power supply elements (28) and the external computer performance elements (32). Sensors as working elements (30) permit a learning capacity by means of the external computer performance elements (32). The buckling arm robot is characterised by a low weight (less than 5.0 kg, preferably less than 3.0 kg) with an active radius of approximately 0.5 m, great flexibility in its modular construction and an advantageous ratio of load capacity to own weight. The invention also relates to the stationary use of buckling robots of this type, to their use as rail-mounted robots or as mobile robots.

### FIELD OF THE INVENTION

The invention relates to a bending-arm robot according to claim 1 and to the use thereof according to claims 28-30.

### BACKGROUND OF THE INVENTION

Mobile robots today have constantly increasing importance. However, most manipulators are lacking as regards their practical usefulness (e.g., [1] Moeller et al., 1998) or are usable only for specific applications ([2] Topping and Smith, 2000). The combination of industrial robot arms and mobile platforms is also scarcely possible, since the requirements for fastening, energy supply, computer power and space requirements are mutually incompatible. [3] Onori et al. (2000) describe a hyper-flexible automatic mounting system. The concept provides for the transition from manual to automatic mounting, so that working steps are gradually automated with small flexible units. The coexistence of manual and automatic operation is emphasized here. It is proposed that respective automation systems are built up from different standardized components. It has not been possible to achieve this principle up to now, however, for reasons of standardization procedures.

[1] Moeller, R., Lambrinos, D., Pfeifer, R., Wehner, R. (1998): Insect strategies of visual homing in mobile robots. Proc. Computer Vision and Mobile Robotics Workshop, CVMR '98, 3745, FORTH, Heraklion, Greece, 1998.

[2] Mike Topping, Jane Smith (2000): Hand 1—A Rehabilitation Robotic System for the Severely Disabled. Proceedings of the 31st International Symposium on Robotics, May 14-17, 2000, Montreal, Canada; pp. 254-257.

[3] Onori M., Alsterman, H., Bergdahl, A., Johansson, R. (2000): Hyper Flexible Automatic Assembly, Needs and Possibilities with Standards Assembly Solutions. Proceedings of the 31st International Symposium on Robotics, May 14-17, 2000, Montreal, Canada; pp. 265-270.

In U.S. Pat. No. 4,641,251, a mechanism is described for protection from unforeseen obstacles. An auxiliary control system is used for this purpose and registers arm sensors and movements which deviate from the programmed movements or from expected sensor signals. The system can be used against various kinds of damage.

According to EP 0616874, a flexible robot arm is known, which is designed for a portable robot with movements up/down and also in two mutually perpendicular horizontal directions. This arm is designed for a mobile platform. This robot is designed for great loads of a specific region of industry. Its weight and the lack of multifarious use are disadvantages.

According to U.S. Pat. No. 4,986,723, an anthropomorphic robot arm is known, with hand, wrist joint, and arm. The hand contains a baseplate, plural flexible fingers each with plural joints, and an opposed thumb which can rotate in one direction. Actuators within the arm drive each degree of freedom independently, so that the same movements are possible as in a human arm.

Furthermore, in U.S. Pat. No. 4,737,697, a teaching method for industrial robots is described. A position encoder generates a signal which indicates the present position of the arm, against which a manually controlled positioning system stores the positions to be assumed. A servo-control system responds to the signals, so that the present position of the arm travels to the desired position during the playback. The arm can be moved manually to the desired position during the training.

According to CN 1,225,523, a miniature robot for medical applications is known. This shows the great advances in miniaturization of robots, and how these can be constructed so that the potential for damage caused by robots remains minimal.

Disadvantages of these systems are that:
(a) the cooperation of humans and robots for performance of a task still functions very poorly, for reciprocal safety reasons,
(b) mounting of bending-arm robots, which take over industrial handling tasks, is too difficult on medium size through small movable systems,
(c) the power electronics is installed in a separate box, which itself limits mobile use due to its large dimensions and its weight,
(d) the robots execute computing power at a central unit, and therefore no “local intelligence” is present in the region of the actuators and sensors, and unnecessarily large cabling is thus required and the possibilities of learning ability of the robots are limited,
(e) no bending-arm robot is available which fulfills both industrial requirements and also can be used in a simple manner for tasks in the home region and also in the service sector,
(f) the working means of the robots do not possess a sensory system which permits the execution of a task under different situations and conditions, and

(g) the ratio of weight to maximum useful load is too high.

### SUMMARY OF THE INVENTION

The present invention has as its object to propose a bending-arm robot in which the power electronics is fully integrated, which has a low weight and an internal, locally distributed computer power, and which possesses learning ability with the use of external computer power, so that the above disadvantages are removed.

According to the invention, this object is attained with a bending-arm robot according to the wording of claim 1.

### BRIEF DESCRIPTION OF THE DRAWINGS

The invention is described in detail hereinafter, using the accompanying drawings.

FIG. 1 shows a schematic diagram of the basic construction of a bending-arm robot,

FIG. 2 shows the construction and arrangement of the driving means,

FIGS. 3A-3B show a gripper arm with rotatably mounted passive joint,

FIG. 4 shows the use of the bending-arm robot on a mobile base,

FIG. 5 shows the use of the bending-arm robot on a linear shaft.

### DETAILED DESCRIPTION OF THE INVENTION

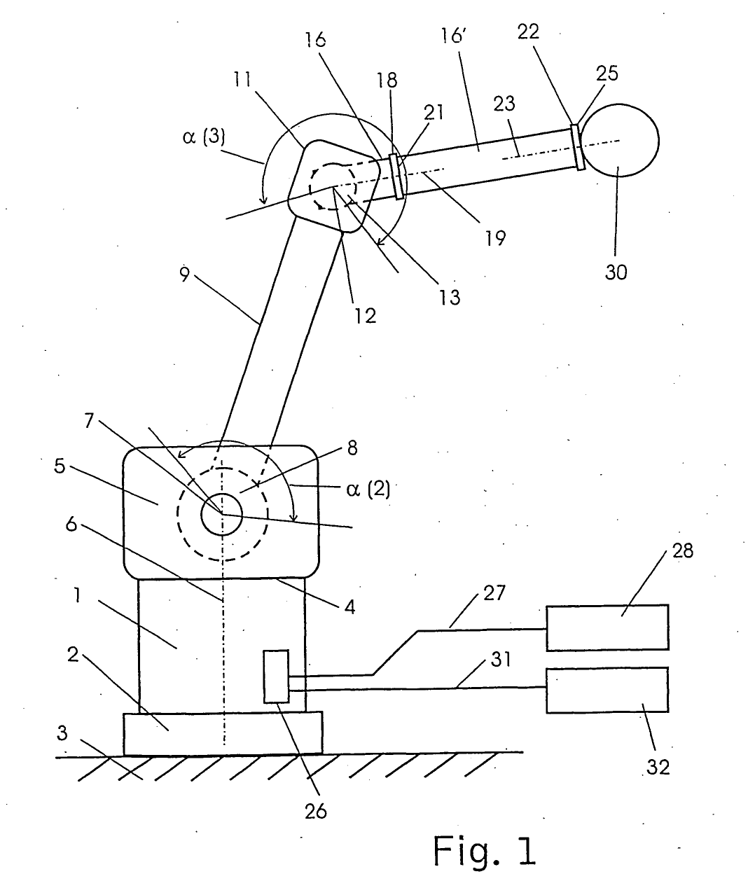

FIG. 1 shows a schematic diagram of the basic construction of a bending-arm robot. A base element 1 has on its underside a fastening element 2 by means of which it is fastened to a baseplate 3. The upper side of the base element has a horizontal surface 4 on which a joint block 5 is placed flush and is mounted for rotation around an axis 6. The joint block 5 and the base element define a first degree of freedom for a movement around the axis 6 with a rotation angle α(1) (not shown) of about 360°.

The axis runs substantially in the center of the base element 1 and joint block 5. A second axis 7 perpendicular to the axis 6 is arranged in the upper portion of the joint block 5. A joint 8 moves around this second axis 7, is surrounded by a cylindrical support tube 9, also known as “upper arm”, and is fixedly connected to this. The support tube 9 and the joint block 5 define a second degree of freedom for a movement of about 150° around the axis 7, indicated by the rotation angle α(2). A second joint block 11 is installed at the other end of the support tube 9, and a third axis 12 parallel to the second axis 7 runs through its center.

A joint 13 moves around this third axis 12, is surrounded by a cylindrical support tube 16, also termed “forearm”, and is fixedly connected to this. The support tube 16 and the second joint block 11 define a third degree of freedom for a movement of about 240°, indicated by the rotation angle α(3), around the axis 12.

The support tube 16 has a closure 18 in the form of a flange, located near the joint block 11 and perpendicular to the support tube axis, with a fourth axis 19 running through its center and parallel to the support tube axis.

The side of the closure 18 remote from the joint 13 has a planar surface 21 on which a portion 16′ of the support tube 16 abuts flush and is mounted for rotation around the fourth axis 19. The portion 16′ of the support tube 16 and the support tube 16 define a fourth degree of freedom for a movement of about 240° around the axis 19, so that a fourth rotation angle α(4) (not shown) is formed.

A flange 22 is fitted at the other end of the support tube 16′, with a fifth axis 23 parallel to the fourth axis 19 running through its center.

The side of the flange 22 remote from the support tube 16′ has a planar surface 25 on which working means 30 or further degrees of freedom 5-7 abut flush with their working means and are respectively rotatably mounted or arranged around the fifth axis 23.

Base element, support tubes, joint blocks and working means are manufactured as milled and turned parts and can therefore be easily dismantled, interchanged, and adapted to specific uses.

An external interface 26 for serial data transfer is mounted in the base element 1. A connecting cable 27 leads from this interface to current supply means 28, and a second connecting cable 31 to external computer power means 32.

The working means 30 are to be understood as grippers and other tools which are required for solving problems. The form and the additional number of degrees of freedom depend on the object to be attained. The presence of plural sensors at decisive positions permits the centering, recognition and categorizing of the objects to be manipulated.

As sensors there are used IR sensors, local force sensors, conductivity sensors, extension sensors, ultrasound sensors, lasers, and a miniature camera. When sensors of different modality are present, a sensor redundancy is formed, which increases learning ability.

A 12 V current supply or a 12 V accumulator is provided as current supply means 28. Use as a mobile robot is also possible with a 12 V accumulator.

Provided as external computer power means 32 is a PC, a laptop, or a processor of another robot, all having high computer power. Thereby plural useful algorithms from the fields of artificial intelligence (learning by neural networks, genetic algorithms, tabu search), kinematics, and so on can run in parallel and change online the values in the processors of the microcontroller. The firmware on the bending-arm robot permits online modification of all parameters used for pilot control and main control; the bending-arm robot is thus able to learn. The software has available an internal database and the possibility of operating learnable algorithms.

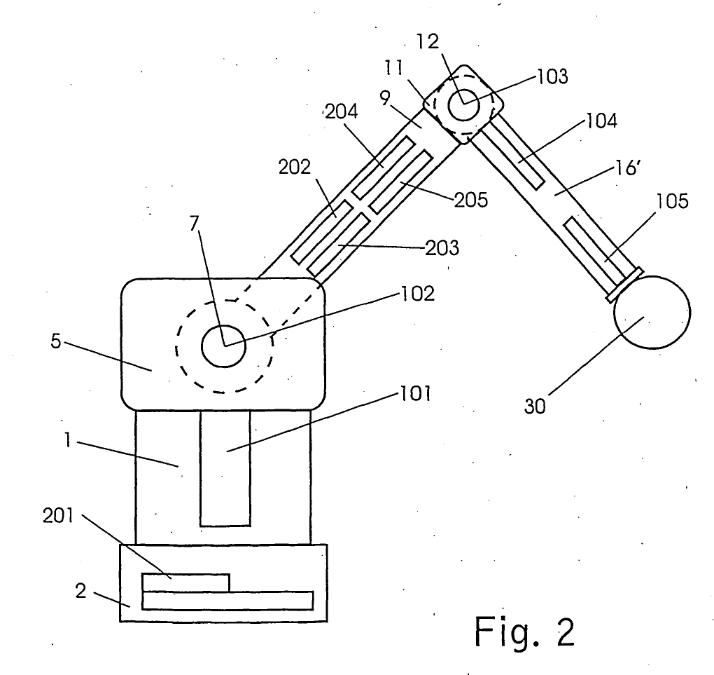

FIG. 2 shows the construction and the arrangement of the drive means. As mechanical drive means there are five motor gear units 101, 102, 103, 104 and 105, of which a first is situated in the base element 1, a second in the joint block 5, a third in the joint block 11, a fourth and a fifth in the support tube 16′. The motor gear units are provided with an incremental encoder which is provided for position sensing. The required wiring of motor and encoder can advantageously be laid together, i.e., only a single junction point is necessary per motor. With the selected position control, a so-called “electrical slippage”, such as is known for stepping motors in the overload case, is absent.

The motor gear units are driven by electrical drive means which consist of five microcontrollers (also termed motor controllers) 201, 202, 203, 304, and 205, of which one is allocated to each of the motor gear units 101, 102, 103, 104 and 105. The first microcontroller 201 is situated in the fastening element 2, and the further microcontrollers 202, 203, 204, and 205 all in the support tube 9.

The microcontrollers are connected to each motor gear unit (not shown) and effect their driving and regulation. Likewise situated in the fastening element 2 is the main board, on which the connections of the microcontroller are brought together and the management of the outer interface takes place. The whole power electronics is situated on the main board and is completely integrated into the robot; this is found to be particularly advantageous.

A digital bus system connects the electrical drive means and the working means 30 with the external interface 26. Analog signals, sensitive to, e.g., magnetic fields over long distances, are omitted. As a result, operation is free from disturbances and accuracy of the movements is higher. Of further advantage is the possibility of expansion with additional controllers without additional leads.

The electrical drive means can have ‘in-circuit’ programmable flash memory, making firmware updates possible without mechanical intervention or exchange of components.

By the arrangement of the motor gear units 102 and 103 in the respective joints, the whole drive is situated axially in the joint axis, i.e., in the second axis 7 or respectively the third axis 12. A transfer of play thereby does not occur through other joints, and in addition this results in a simplification of mounting and maintenance. Commercial motor gear units are used, avoiding external, expensive gears.

Ball or slide bearings are used for mounting the joints, since these permit exact guiding with low friction. This is especially important for the suspension of the fourth degree of freedom (rotation of the “forearm”, or of the support tube 16′), and thereby an optimum pressure equalization is ensured when the load distribution is asymmetrical.

Due to the arrangement of the power electronics within the bending-arm robot, fewer external devices and cables are required. The cabling takes place internally, so that mechanical damage is minimized.

Due to the arrangement of the microcontroller as near as possible to the motor gear units, particularly advantageous short cable lengths result, of which the longest pass over at most one joint. This arrangement furthermore defines overall an internal computer power which is present locally with the mechanical drive means and the working means 30 and thereby forms a local intelligence.

Since a microcontroller is allocated to each motor gear unit for drive and control, this approach to solution is different from the usual robots, in which multiple management of all the movements is effected from an external common controller. The advantages of the present solution are the independence of the software of different motor axes, which offers a higher functional reliability, smaller required computer power per chip or per microcontroller, and fewer peripheral connections. This leads to so-called ‘low cost microcontrollers’.

Since the position control for each axis takes place locally, very short reaction times result, in contrast to control by a central computer via a digital bus. The control parameters can be changed online by means of superordinate control units (main board, external computer).

The design of the mechanical components, particularly the joint blocks 5 and 11, but also the base element 1 and the working means 30, with rounded edges, ensures a low danger of injury.

A bending-arm robot with only four motor gear units and microcontrollers is also conceivable, according to the desired use.

The bending-arm robot is operated with very low voltage and has a very low energy consumption. The maximum power uptake is 30 watts. Because of the limited forces, no special safety rules have to be maintained. Any kind of protective screen, such as are usual for current industrial robots, can be dispensed with. Use is therefore possible in a very small space where humans have direct access.

When a force acts suddenly on the support tubes or the working means, e.g., a gripper, a defined place in the structure has to yield, as is logically the case for a predetermined breaking place. This place is located at the transition to aluminum construction. The fastening screws which connect the motor shaft to the aluminum construction yield at too great a pressure and can also be quickly replaced after action of an excessive force.

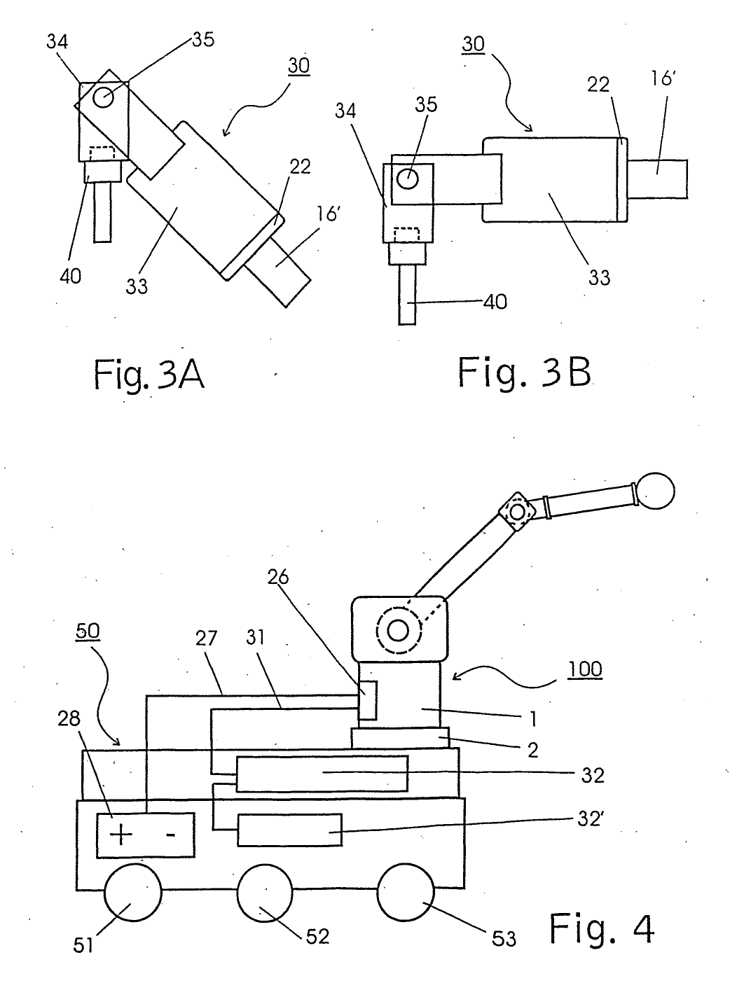

FIGS. 3A and 3B show a gripper arm with a rotatably mounted passive joint mounted thereon as working means. The working means 30 are mounted on the flange 22 of the support tube 16′, and consist of a gripper arm 33 and a passive joint 34. The passive joint, constituted as a gripper jaw, is rotatably mounted at the place 35 and is to always hold a load 40, e.g., a metal object, vertical under the action of gravity. There thereby results a reduced computer cost and a simplified construction, in contrast to a solution with an active joint or a parallelogram guide.

The bending-arm robot according to the invention, because of its smallness, or because of the compact mode of construction, permits working in a narrow space. Thus in the inoperative condition it has a maximum dimension of 10.5 cm×33 cm×33 cm, with a working radius of about 0.5 m. The inoperative position means the position with the rotation angles α(2)=150° and α(3)=0°. It is thus also easily transportable.

Such a mode of construction gives a weight of less than 5.0 kg, preferably less than 3.0 kg. Current supply means and external computer power means are not considered. In spite of the smallness, it has been found that the ratio of weight to useful load is about equal to 5.0, which is very advantageous; this with a weight of 2.5 kg and a useful load of 0.5 kg. This ratio is substantially more unfavorable for all known bending-arm robots.

It has excellent suitability for interactive work with a human work force and permits so-called “hand in hand” work.

Because of the modular construction, the working range can, e.g., be widened in a simple manner by a telescopic piece in place of the support tube 16′, while the compact mode of construction is retained.

A bending-arm robot according to FIGS. 1 and 2 is described as an embodiment example. The working means corresponds to a gripper with two fingers and rotatably mounted passive joints installed thereon according to FIGS. 3A-3B.

Maxon DC motors and planetary gears are used as driving elements, i.e., motor gear units, for all joints. For example, for the first motor gear unit: Type Maxon RE 15 DC 1.6 watt, external diameter 15 mm, torque 0.5 Nm, planetary gear 455:1. Encoder RE 16, resolution 0.05.

PICs (Microchip Embedded Control Solutions Company) are used as local processors for the master and slave boards. The connection between the boards, or respectively the sensors and actuators, takes place partially with ribbon cables and partially with flexible printed boards. Coil springs are built in to reduce play.

The bending-arm robot is preferably operated on a stationary support.

FIG. 4 shows the use of the bending-arm robot as a mobile robot. A bending-arm robot 100 according to FIGS. 1 and 2 is mounted by means of its fastening element 2 on a traveling base 50 with wheels 51, 52, 53. The current supply means 28 is constituted as a 12 V accumulator and is situated on the base 50. The current supply of the bending-arm robot is ensured by means of the connecting cable 27 to the external interface 26 on the base element 1. As external computer power means, a PC 32 connected to a computer 32′ (e.g., Motorola) is provided, and is likewise situated on the base 50. The PC 32 is connected to the external interface 26 by means of the connecting cable 31. The PC 32 can be omitted for simple uses.

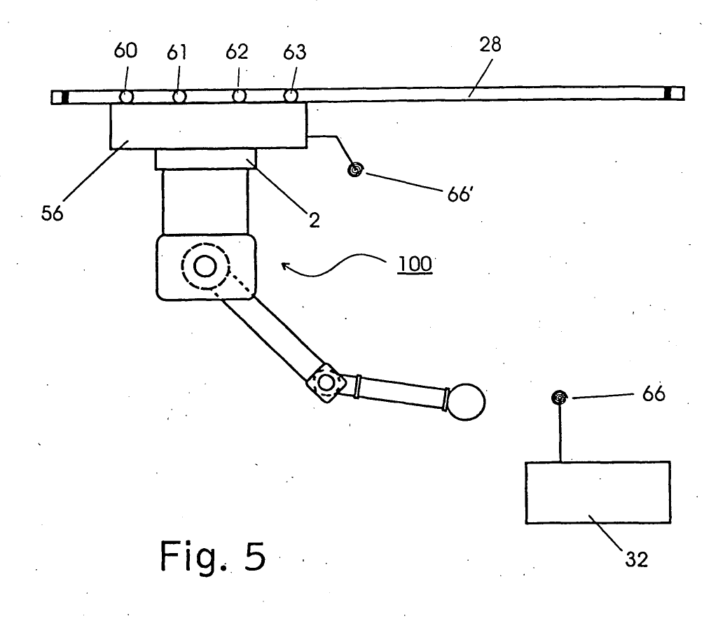

FIG. 5 shows the use of the bending-arm robot, rail-guided on a linear axis. This guiding can take place so that the bending-arm robot 100 is mounted suspended. The fastening element 2 is mounted on a linear drive 56 which provides guiding by means of rollers 60-63 on a linear shaft 28 which simultaneously delivers the current supply. A PC or laptop acts as external computer power 32 and communicates with the linear drive 56 or with the bending-arm robot 100 via a radio unit 66. The linear drive 56 is provided with a further radio unit 66′ for this purpose.

1. Bending-arm robot comprising a base element, at least two joint blocks, at least three support tubes, working means, mechanical and electrical driving means, and current supply means, wherein the mechanical drive means consist of at least four motor gear units which are situated in the base element, in the joint blocks, and in the support tubes; wherein the electrical driving means consist of at least four microcontrollers, which are situated in the base element and in the support tube, a microcontroller being allocated to, connected to, and arranged near to, each motor gear unit; wherein a digital bus system connects the electrical driving means and the working means with an external interface situated in the base element; wherein the interface is connected via a connecting cable to the current supply means and via a second connecting cable (31) to the external computer power means; wherein the arrangement of the microcontrollers confers an internal computer power which is present distributed locally with the mechanical drive means and the working means and thereby forms a local intelligence; wherein the mechanical driving means are provided for the movement of the joint blocks, the support tubes, and the working means; wherein for this purpose the local intelligence is available in the electrical driving means and an external intelligence is available in the external computer power means; and wherein the whole power electronics is integrated.

2. Bending-arm robot according to claim 1, wherein a first motor gear unit with the associated microcontroller is situated in the base element, and is provided for movement around a first axis with a rotation angle α of about 360°.

3. Bending-arm robot according to claim 1, wherein a second motor gear unit in the joint block lies axially in the joint axis, or respectively the second axis; wherein the associated microcontroller is situated in the support tube and is provided for movement around a second axis with a rotation angle α of about 150°.

4. Bending-arm robot according to claim 1, wherein a third motor gear unit lies axially in the joint axis, or respectively the third axis, in the second joint block; wherein the associated microcontroller is situated in the support tube and is provided for movement around a third axis with a rotation angle α of about 240°.

5. Bending-arm robot according to claim 1, wherein a fourth motor gear unit is situated in the support tube and the associated microcontroller is situated in the support tube and is provided for the movement around a fourth axis with a rotation angle α of about 240°.

6. Bending-arm robot according to claim 1, wherein a fifth motor gear unit is situated in the support tube and the associated microcontroller is situated in the support tube and is provided for the movement of the working means around a fifth axis.

7. Bending-arm robot according to claim 1, wherein the support tubes are easily detachable from the joint blocks or the working means, respectively, and are interchangeable, and adaptable specifically according to use.

8. Bending-arm robot according to claim 1, wherein the support tube is of telescopic construction.

9. Bending-arm robot according to claim 1, wherein the mechanical driving means have an incremental encoder for position determination and provided for position control, the signal evaluation taking place directly by means of the associated microcontroller of the electrical driving means, or respectively locally per axis.

10. Bending-arm robot according to claim 9, wherein the incremental encoder is integrated into the motor block of the corresponding motor gear unit.

11. Bending-arm robot according to claim 1, wherein the working means contain sensors.

12. Bending-arm robot according to claim 11, wherein as sensors there are provided IR sensors, local force sensors, conductivity sensors, extension sensors, ultrasound sensors, lasers and a miniature camera.

13. Bending-arm robot according to claim 11, wherein sensors of different modality are present which form a sensor redundancy which increases learning ability.

14. Bending-arm robot according to claim 1, wherein the working means are constituted as gripper arms with a rotatably mounted passive joint contained therein and always remaining in a vertical alignment, using gravity.

15. Bending-arm robot according to claim 1, wherein adaptive controls and predictive parameters are provided for the movements of the joint blocks, the support tubes and the working means, the means for external computer power being available for their operation or respectively for their calculation, and learning ability is conferred by means of artificial intelligence algorithms.

16. Bending-arm robot according to claim 1, wherein operation takes place free from protective screens.

17. Bending-arm robot according to claim 1, wherein it weighs less than 5.0 kg, preferably less than 3.0 kg.

18. Bending-arm robot according to claim 1, wherein the ratio of weight to useful load is up to a minimum of 5.0.

19. Bending-arm robot according to claim 1, wherein in the inoperative position it has maximum dimensions of 10.5 cm×33 cm×33 cm.

20. Bending-arm robot according to claim 1, wherein the support tube has a flange, on which the digital bus system is available to the working means at the interface.

21. Bending-arm robot according to claim 1, wherein the electrical driving means have in-circuit programmable flash memory which makes firmware updates possible without the necessity for mechanical intervention or an interchange of components.

22. Bending-arm robot according to claim 1, wherein the current supply means consist of a 12 V accumulator.

23. Bending-arm robot according to claim 1, wherein the maximum power consumption is 30 watts.

24. Bending-arm robot according to claim 1, wherein the base element, the joint blocks, and the working means have rounded edges.

25. Bending-arm robot according to claim 1, wherein a protective place per rotation axis is present by means of fastening screws at the transition from the motor shaft to the aluminum construction, and ensures protection against the action of excessive forces.

26. Bending-arm robot according to claim 1, wherein ball bearings or slide bearings are provided for mounting.

27. Bending-arm robot according to claim 1, wherein the cabling takes place internally.

28. Use of the bending-arm robot according to claim 1, fixedly mounted on a stationary base.

29. Use of the bending-arm robot according to claim 1, on a traveling base as a rail-guided robot.

30. Use of the bending-arm robot according to claim 1, on a traveling base as a mobile robot.

31. Bending-arm robot comprising a base element, at least two joint blocks, at least three support tubes, working means, mechanical and electrical driving means, and current supply means, wherein the mechanical drive means consist of at least four motor gear units which are situated in the base element, in the joint blocks, and in the support tubes; wherein the electrical driving means consist of at least four microcontrollers, which are situated in the base element and in the support tube, a microcontroller being allocated to, connected to, and arranged near to, each motor gear unit; wherein the arrangement of the microcontrollers confers an internal computer power which is present distributed locally with the mechanical drive means and the working means and thereby forms a local intelligence; wherein an external intelligence is available in the external computer power means; and wherein a protective place per rotation axis is present by means of fastening screws at the transition from the motor shaft of the electrical driving means to the aluminum construction, which ensures protection against the action of excessive forces.

32. Bending-arm robot according to claim 31, wherein the fastening screws yield at too great a pressure and are quickly replaced after action of an excessive force.

33. Bending-arm robot according to claim 31, wherein the maximum power consumption is 30 watts and wherein because of the limited occurring forces operation is possible in a very small space where humans have direct access.

34. Bending-arm robot according to claim 31, wherein the working means as sensors there are provided IR sensors, local force sensors, conductivity sensors, extension sensors, ultrasound sensors and/or lasers.

35. Bending-arm robot according to claim 34, wherein sensors of different modality are present which form a sensor redundancy which increases learning ability.

36. Bending-arm robot according to claim 31, wherein adaptive controls and predictive parameters are provided for the movements of the joint blocks, the support tubes and the working means, the means for external computer power being available for their operation or respectively for their calculation, and learning ability is conferred by means of artificial intelligence algorithms.
